(19) United States
(12) Patent Application Publication
(10) Pub. No.: US 2014/0147672 A1
(43) Pub. Date: May 29, 2014

(54) ELECTRICALLY CONDUCTIVE PARTICLES AND PROCESS FOR PRODUCTION THEREOF

(71) Applicants: Noriji Tashiro, Hitachi-shi (JP); Kouichi Kamijima, Hitachi-shi (JP)

(72) Inventors: Noriji Tashiro, Hitachi-shi (JP); Kouichi Kamijima, Hitachi-shi (JP)

(73) Assignee: HITACHI CHEMICAL COMPANY, LTD., Chiyoda-ku, Tokyo (JP)

(21) Appl. No.: 13/882,943

(22) PCT Filed: Nov. 1, 2011
(86) PCT No.: PCT/JP2011/075203

§ 371 Date: Jun. 3, 2013

(30) Foreign Application Priority Data
Nov. 2, 2010 (JP) 2010-246242

(51) Int. Cl. H01B 1/24

(52) U.S. Cl. CPC H01B 1/24
USPC 428/402; 252/511

(57) ABSTRACT

Conductive particles containing at least a carbon-based conductive material and a binder resin, and having an average particle size of 50 μm or less, in which a pressure for causing deformation by 40% of a particle size of the conductive particles at 25° C. is 12 MPa or less, or a mass ratio of the binder resin relative to the carbon-based conductive material is 1/99 to 70/30.

### TECHNICAL FIELD

The present invention relates to conductive particles and a method of production thereof.

### BACKGROUND ART

In accordance with rapid performance improvement, (digitalization) of electric products in the recent years, it has become a significant problem in product design to suppress power consumption by supplying more stable power to a densified electric circuit. As a result of this, a conductive interconnection material capable of quickly attaining electrical conduction among electrodes formed on a plurality of circuit boards included in a device is indispensable.

In general, in order to improve a handling property and prevent a short-circuit caused by scatter of a conductive powder, a conductive interconnection material having the aforementioned property is provided in the form of a paste or a film containing a conductive powder homogeneously dispersed in a binder component.

As the conductive powder contained in the conductive interconnection material, fine plastic beads having an appropriate elastic modulus and plated with metal are generally used (see Patent Literature 1).

### CITATION LIST

### Patent Literature

Patent Literature 1: Japanese Unexamined Patent Application Publication No. 62-188184

### SUMMARY OF INVENTION

### Technical Problem

For obtaining the conductive powder, however, there are a large number of requirements; for example, it is necessary to homogenize (classify) the particle size of plastic beads to be used, to use a plating material of an expensive metal (such as a rare metal), and to conduct a plating solution waste treatment.

Accordingly, an object of the present invention is to provide conductive particles that have high conductivity even without metal plating and can be produced by a simple process, and a method of production thereof.

### Solution to Problem

The present invention provides conductive particles containing at least a carbon-based conductive material and a binder resin, and having an average particle size of 50 μm or less, in which a pressure for compressing a particle size of the conductive particles to 40% of the particle size under no compression is 12 MPa or less. The conductive particles of the present invention can be conductive particles containing at least a carbon-based conductive material and a binder resin for binding the carbon-based conductive material and having an average particle size of 50 μm or less, in which a mass ratio of the binder resin relative to the carbon-based conductive material is 1/99 to 70/30. Incidentally, that the mass ratio of the binder resin relative to the carbon-based conductive material is 1/99 to 70/30 means that a ratio of (the mass of the binder/the mass of the carbon-based conductive material) is 1/99 to 70/30.

Such conductive particles have characteristics that the conductivity is high even without metal plating and that they can be produced by a simple process.

When the above-described conductive interconnection material in the form of a film is put between members having circuit electrodes with the circuit electrodes opposing each other and heated/compressed (which process is sometimes designated as “mounting”), the conductive powder dispersed in the film makes electrical conduction between these circuit electrodes possible as well as the members are connected to each other. At this point, in order to improve the conductivity between the conductive powder and the circuit electrodes, it is a significant point to increase a contact area of the conductive powder with the circuit electrodes.

The increase of the contact area between the conductive powder and the circuit electrodes is generally attained by deformation of the conductive powder. Here, the contact area means an area of interfaces on which the circuit electrodes are in contact with the conductive powder, and if the deformation of the conductive powder is too large, stable conductivity cannot be attained because, for example, powder particles of the conductive powder come into contact with one another. On the other hand, with respect to a film-shaped conductive interconnection material using, as the conductive powder, a simple metal powder, a simple graphite powder or the like, since the elastic modulus of the conductive powder is so large that the conductive powder is difficult to deform even when a mounting operation is conducted; and therefore, it is difficult to increase the contact area with the circuit electrodes. Although it is possible to increase the deformation of the conductive powder by increasing a pressure applied in mounting the film-shaped conductive interconnection material, this is undesirable because, if a simple metal powder is used as the conductive powder, there is a fear of damage or deformation of a circuit board and the circuit electrodes, or if a simple graphite powder is used as the conductive powder, there is a fear of conduction failure or a short-circuit caused by crumbling of the simple graphite powder.

The conductive particles of the present invention overcome these problems; the particles need not be provided with a metal plating layer and are inexpensive; and when a conductive interconnection material containing them is put on an electric circuit and heated/compressed, a sufficient contact area with the circuit can be attained, and the conductivity is excellent.

The binder resin preferably contains a non-water soluble elastic resin. The non-water soluble elastic resin is advantageous from the viewpoint of easiness in production of the conductive particles because it can be provided in the form of an emulsion or latex particles. Incidentally, an elastic resin means a resin having an elastic modulus obtained by measurement of dynamic viscoelasticity of 10⁵ to 10⁹ Pa (preferably 10⁵ to 10⁸ Pa) (with a measurement frequency for the dynamic elastic modulus of, for example, 10 Hz), and the elastic resin preferably shows this elastic modulus at room temperature (25° C.).

The binder resin may further contain a water soluble resin. Since a water soluble resin can function as a granulation assistant, the production of the conductive particles can be thus made easier, and conductive particles excellent in deformability and having higher conductivity can be thus obtained.

As the non-water soluble elastic resin, a resin having a glass transition temperature (Tg) of −30° C. to 110° C. is useful. When the Tg falls in this temperature range, deformation caused in mounting can be easily followed, and when the non-water soluble elastic resin is blended in a conductive interconnection material, high conductivity can be secured. Incidentally, the Tg can be measured by using a differential scanning calorimeter (DSC) on a sample, which is obtained by producing a self-supporting film with a solvent dried and cutting the film into a prescribed size, under conditions of a starting temperature of −100° C. and a temperature increase rate of 10° C./min.

The carbon-based conductive material is preferably carbon black. When carbon black is used, good electrical conduction can be attained even without metal plating with a rare metal. In particular, Ketjen black is useful because it has a hollow structure and has particularly high conductivity as a carbon-based conductive material.

The present invention also provides a method of production of conductive particles, spraying a composition in which a carbon-based conductive material and a binder resin are mixed in a medium and a mass ratio of the binder resin relative to the carbon-based conductive material is 1/99 to 70/30 to volatilize the medium, and to granulate the composition while binding the carbon-based conductive material with the binder resin.

In this method of production, the carbon-based conductive material is bound by the binder resin in a state where it has been changed into the form of particles by spraying, and therefore, the conductive particles having the aforementioned properties can be easily produced.

In this case, an average particle size of the conductive particles to be produced is preferably 50 μm or less. Furthermore, for the aforementioned reason, it is preferable that the binder resin contains a non-water soluble elastic resin and that it further comprises a water soluble resin.

When an average particle size of the carbon-based conductive material is 10 nm to 700 nm and an average particle size of the non-water soluble elastic resin is 50 nm to 700 nm, conductive particles having an average particle size of 50 μm or less and having the aforementioned properties can be easily produced. Here, an average particle size means a particle size corresponding to accumulation of 50% in a particle size distribution obtained by a laser diffraction and scattering method (a median diameter D50).

### Advantageous Effects of Invention

According to the present invention, conductive particles that have high conductivity even without metal plating and can be produced by a simple process, and a method of production thereof can be provided.

### BRIEF DESCRIPTION OF DRAWINGS

FIG. 1 is a scanning electron microphotograph of conductive particles of Example 1.

FIG. 2 is another scanning electron microphotograph of the conductive particles of Example 1.

FIG. 3 is a scanning electron microphotograph of conductive particles of Example 2.

FIG. 4 is a scanning electron microphotograph of conductive particles of Comparative Example 1.

FIG. 5 is a graph illustrating a relationship between a deformation volume of a particle size of conductive particles and a pressure.

### DESCRIPTION OF EMBODIMENTS

Conductive particles of the present embodiment contain at least a carbon-based conductive material and a binder resin for binding the carbon-based conductive material.

The carbon-based conductive material contained in the conductive particles is carbon particles having conductivity, and an average particle size (a primary particle size) thereof is preferably 10 to 700 nm, more preferably 20 to 400 nm and particularly preferably 30 to 100 nm.

As the carbon-based conductive material, carbon black is useful. As for the carbon black, those obtained by any production process can be employed, and Ketjen black, furnace black, channel black, acetylene black, thermal black and the like are applicable. As for the carbon black, from the viewpoint of cost, properties of granulating/complexing with the binder resin (such as particle size control) and environment/safety, it is preferable to use those homogeneously dispersed in water. A dispersant may be added to the water.

In considering the conductivity, the amount of use, and the miscibility with another material, Ketjen black having a large specific surface area and having a hollow shell-shaped structure is particularly preferably used as the carbon-based conductive material. As for properties of Ketjen black, Ketjen black dispersed in water containing a dispersant and having an average particle size (a secondary particle size) of 100 to 600 nm is preferred, and Ketjen black having an average particle size of 100 to 400 nm is more preferred. As such Ketjen black, for example, Lion Paste W-310A, Lion Paste W-311N, Lion Paste W-356A, Lion Paste W-376R, Lion Paste W-370C (all manufactured by Lion Corporation, trade names) and the like can be used.

The content of the carbon-based conductive material is, based on a total mass together with the binder resin, preferably in a range of 30 to 99% by mass, more preferably in a range of 35 to 95% by mass, still more preferably 50 to 95% by mass, particularly preferably 50 to 90% by mass, and most preferably 70 to 90% by mass. In other words, a mass ratio of the binder resin relative to the carbon-based conductive material is preferably 1/99 to 70/30, more preferably 5/95 to 65/35, still more preferably 5/95 to 50/50, particularly preferably 10/90 to 50/50, and most preferably 10/90 to 30/70.

By setting the content of the carbon-based conductive material to 99% by mass or less, an effect of the contained binder resin to bind the carbon-based conductive material can be improved, and granulation of the conductive particles into μm size by complexing is eased. Furthermore, by setting the content of the carbon-based conductive material to 30% by mass or more, degradation in the conductivity of the conductive particles to be obtained can be prevented.

The binder resin that is another indispensable component of the conductive particles has a function to bind the carbon-based conductive material.

The kind of the binder resin is not questioned as long as it has such a function, but the binder resin preferably contains at least a non-water soluble elastic resin. The non-water soluble elastic resin is preferably one provided in the form of a latex, namely, in the form of rubber particles dispersed in water. The rubber particles have an average particle size of typically 50 to 700 nm (preferably 70 to 500 nm) and may be dispersed in water together with a dispersant.

Examples of a rubber component of the rubber particles include styrene-butadiene-based rubbers, polybutadiene-based rubbers and acrylonitrile-butadiene-based rubbers. One kind of or a mixture of two or more kinds of these rubber particles can be used. Incidentally, as a rubber component, one modified with a carboxyl group or the like can be employed, and such a rubber component is excellent in hydrophilicity, miscibility, adhesive properties and the like.

The rubber particles may have either a single-layered structure or a multilayered structure (such as a core shell structure). Alternatively, those having a hollow structure can be employed.

When rubber particles having a low glass transition temperature (Tg) is selected as the non-water soluble elastic resin, conductive composite particles having a small elastic modulus (to be soft) can be designed, and when rubber particles having a high Tg is selected, conductive composite particles having a large elastic modulus (to be hard) can be designed. Alternatively, when rubber particles having different Tgs are blended, conductive composite particles having a desired elastic modulus can be adjusted.

From the viewpoint of designing conductive composite particles having an appropriate elastic modulus, the Tg of the rubber component is preferably −30 to 110° C., more preferably 0° C. to 110° C. and particularly preferably 10° C. to 110° C.

In the case of using rubber particles of a multilayered structure or a mixture of a plurality of rubber particles, there may be a plurality of Tgs in some cases, and in such cases, it is sufficient that any one of the Tgs falls in the aforementioned range.

In the case where two or more kinds of rubber particles are blended to be used, if, for example, the elastic modulus is desired to be increased (to make the particles harder) and furthermore the particle size is desired to be increased, rubber particles having a high Tg and rubber particles having a low Tg can be blended for making these particles share the functions, so that the elastic modulus may be increased by the high Tg rubber particles and the particle size can be increased by the low Tg rubber particles with high tackiness.

For making the conductive particles sufficiently exhibit functionality, it is necessary to produce particles having a stable prescribed particle size, and for this purpose, selection of an initial particle size of the rubber particles in the latex to be used is significant. From this point of view, it is suitable to use, as the latex, for example, Nipol LX430 (average particle size of contained rubber particles: 150 nm, Tg: 12° C.), Nipol LX433C (average particle size of contained rubber particles: 100 nm, Tg: 50° C.), Nipol 2507H (average particle size of contained rubber particles: 250 nm, Tg: 58° C.), Nipol LX303A (average particle size of contained rubber particles: 160 nm, Tg: 100° C.), Nipol LX416 (average particle size of contained rubber particles: 110 nm, Tg: 50° C.), Nipol PHT 8052 (average particle size of contained rubber particles: 320 nm, two-layered structure particles (core portion Tg: 100° C., shell portion Tg: 0° C.) (all manufactured by Zeon Corporation, trade names) or the like. Incidentally, if the average particle size of the rubber is difficult to measure by the laser diffraction and scattering method, it is calculated as an arithmetic mean obtained in a range observed with a scanning probe microscope.

As described above, the mass ratio of the binder resin relative to the carbon-based conductive material is preferably 1/99 to 70/30, more preferably 5/95 to 65/35, still more preferably 5/95 to 50/50, particularly preferably 10/90 to 50/50 and most preferably 10/90 to 30/70.

By setting the content of the binder resin to 10% by mass or more of the total amount of the binder resin and the carbon-based conductive material, a sufficient content for binding the carbon-based conductive material can be attained, and hence, the number of contacts between particles of the binder resin and between the binder resin and the conductive particles can be prevented from decreasing, and conductive particles having an aimed particle size (μm) can be more easily obtained. By setting the content of the binder resin to 70% by mass or less of the total amount, an increase of the binder resin component not conductive can be prevented, and hence, the conductivity of the conductive particles can be retained high, aggregation of the conductive particles can be prevented, and expression of the functions as fine particles is good.

The aforementioned binder resin may further contain a water soluble resin apart from the non-water soluble elastic resin. The water soluble resin can be made to function as a granulation assistant in the production of the conductive particles.

Specifically, if the elasticity of the conductive particles is desired to be increased (to make the particles harder), there arises a limit in attaining both a high elastic modulus and granulation of particles of size by blending high Tg rubber particles and low Tg rubber particles as described above. In this case, a water soluble resin that can be dissolved in water as a third component can be blended as a granulation assistant. Thus, the high Tg rubber particles with poor tackiness can be granulated together; the conductive particles can be granulated together; or the high Tg rubber particles and the conductive particles can be granulated together, so that a high elastic modulus and granulation of particles of μm size can be achieved. As the water soluble resin, polyvinyl alcohol whose elastic modulus can be adjusted in accordance with a molecular weight, or the like is suitably used.

The conductive particles contains the carbon-based conductive material and the binder resin described above as the indispensable components, but a metal powder can be contained apart from them as long as the functions of the conductive particles are not inhibited. Furthermore, from the viewpoint of improving durability at a high temperature and high humidity, the conductive particles may be plated with metal.

The average particle size of the conductive particles is 50 μm or less. In considering the application to an interconnection material for a circuit electrode, the average particle size of the conductive particles is preferably 1 to 20 μm, more preferably 2 to 15 μm and particularly preferably 3 to 10 μm.

As for the conductive particles, a pressure for causing deformation by 40% (a pressure necessary for compressing the particle size of the conductive particles to 40% of that under no compression) at 25° C. is 12 MPa or less, but for example, from the viewpoint that the area of interfaces where a circuit electrode is in contact with the conductive powder can be efficiently increased, the pressure is preferably 10 MPa or less and particularly preferably 9 MPa or less. The lower limit of the pressure for causing deformation by 40% is not especially limited, but from a practical point of view, the pressure is preferably 1 MPa or more, more preferably 2 MPa or more and particularly preferably 3 MPa or more. Furthermore, for example, from the viewpoint that contact among the conductive particles caused because the area of the interfaces where the circuit electrode is in contact with the conductive powder is too large can be suppressed, a pressure for causing deformation by 50% is preferably 13 MPa or more, more preferably 15 MPa or more and particularly preferably 16 MPa or more. The upper limit of the pressure for causing deformation by 50% is not especially limited, but from a practical point of view, the pressure is 100 MPa or less. Here, assuming that an conductive particle having a particle size of a μm attains, when a pressure is applied along one direction, a diameter of b μm along the pressure direction, deformation by 40% means that {(a−b)/a}×100=40 and deformation by 50% means that {(a−b)/a}×100=50. Furthermore, the conductive particles preferably retain the particle shape even in the deformation by 50%.

A relationship between a pressure and a deformation volume can be measured, for example, by using MCT series, a micro compression tester manufactured by Shimadzu Corporation.

The conductive particles can be obtained by homogeneously mixing the carbon-based conductive material and the binder resin (that preferably contains the non-water soluble elastic resin and may contain the water soluble resin as a granulation assistant) and granulating them with the carbon-based conductive material bound by the binder resin.

Examples of a mixing method include a method of mixing the components by a general stirring machine having a rotating impeller, a method for mixing the components by vibrating them by ultrasonic waves, and a method in which the stirring mixture and the ultrasonic vibration are simultaneously conducted. A determination whether or not the used components have been homogeneously mixed can be made on the basis of, for example, measurement of the viscosity of the mixture (measurement of samples obtained in several portions), observation with an electron microscope, or an amount of a solid matter obtained by removing moisture by heating (measurement of samples obtained in several portions).

The production of the conductive particles is preferably conducted by an apparatus that dries and thermally complexes/granulates a sprayed material. In particular, production conducted by using an apparatus including a liquid mixture sprayer, a spray dryer and a dried matter collecting device is effective because inexpensive and stable production can be thus conducted.

Specifically, a method of spraying a composition in which a carbon-based conductive material and a binder resin are mixed in a medium (having a mass ratio of the carbon-based conductive material to the binder resin of 1/99 to 70/30) to volatilize the medium, and to granulate the composition while binding the carbon-based conductive material with the binder resin can be employed.

Examples of the medium to have the carbon-based conductive material and the binder resin in it include water, alcohols (such as a lower alcohol having 1 to 3 carbon atoms) and non-alcoholic organic solvents, and the medium is preferably water because the carbon-based conductive material can be provided as a water dispersion and the binder resin can be also provided as a latex dispersed in water.

In order to efficiently conduct the spraying of the composition and the volatilization of the medium, it is suitable to use a nozzle having a hole for discharging the composition and a hole for discharging compressed air and to discharge the composition and the compressed air at the same time toward a drying chamber kept at 100 to 200° C.

Incidentally, in the case where further heat resistance and strength are desired to be provided to the obtained conductive particles, means for heat treating the obtained conductive particles may be practiced. A heat treatment can be practiced by performing a treatment with a heating oven used at a furnace temperature of 100° C. to 150° C. for approximately 1 hour. In this manner, even if a crosslinking component of the rubber remains untreated in the granulation, crosslinkage can proceed.

If a further uniform particle size is required, the obtained conductive particles can be classified. An example of a classifying method includes cyclone classification.

The electrical conductivity of the conductive particles at 25° C. is preferably 1 S/cm or more, more preferably 5 S/cm or more, particularly preferably 20 S/cm or more and most preferably 30 S/cm or more. The upper limit of the electrical conductivity may be as high as possible, but in consideration of the electrical conductivity of the carbon-based conductive material, the electrical conductivity is 1000 S/cm or less.

The electrical conductivity of the conductive particles at 25° C. can be calculated by measuring volume resistivity of the powder under arbitrary pressure with, for example, a powder resistivity meter by using a power probe unit (4-point probe, ring electrode).

### EXAMPLES

Now, the present invention will be described in detail on the basis of examples, but the present invention is not limited to them.

### Example 1

### (1) Preparation of Material for Conductive Particles

A latex rubber manufactured by Zeon Corporation, trade name: Nipol LX430 (a styrene-butadiene rubber, average particle size: 150 nm, Tg: 12° C., rubber solid content: 48%): 100 g (rubber component: 48 g), used as rubber particles, and Ketjen black water dispersion manufactured by Lion Corporation, trade name: Lion Paste W-311N (primary particle size: 40 nm, water dispersed particle size: 400 nm or less, Ketjen black content: 8.1%): 1770 g (amount of Ketjen black: 143.4 g), used as a carbon-based conductive material, were weighed (so as to attain a ratio, in terms of mass, of the rubber solid content/the amount of Ketjen black of 25/75), and 300 g of pure water was added thereto.

The thus obtained compound was stirred/mixed for 1 hour with a motor on which a stirring impeller was set (at room temperature: 25° C.), so as to prepare a water dispersion type material for conductive particles.

### (2) Preparation of Conductive Particles

A spray dryer apparatus (manufactured by Ohkawara Kakohki Co., Ltd., trade name: NL-5) was used for spraying the water dispersion type material for conductive particles prepared in (1) above under conditions of a spray air pressure: 0.2 MPa, a dryer inlet temperature: 200° C., an outlet temperature: 90° C., and material throughput: 2.3 kg/h, so as to obtain conductive particles.

### (3) Measurement of Conductivity

A powder resistivity meter (manufactured by Mitsubishi Chemical Analytech Co., Ltd., trade name: MCP-PD51) was used for measuring the conductivity (electrical conductivity, volume resistivity) at 25° C. of the conductive particles prepared in (2) above under measurement conditions of a measurement start range: 10⁻³Ω, an applied voltage limiter: 90 V, a used probe: 4-point probe, an electrode spacing: 3.0 mm, an electrode radius: 0.7 mm, a sample radius: 10.0 mm, a sample mass: 0.9 g, and a measurement pressure: 37.5 MPa.

### (4) Shape and Particle Size Distribution of Conductive Particles

Shape observation: A scanning electron microscope (manufactured by Hitachi, Ltd., trade name: S-4500) was used for observing the shape of the conductive particles prepared in (2) above.

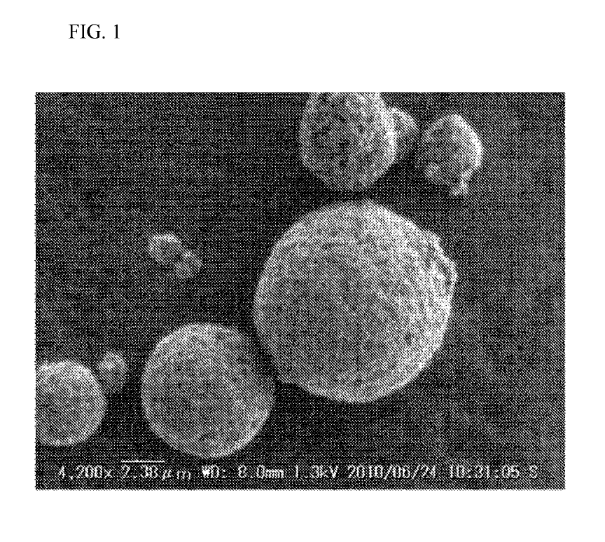

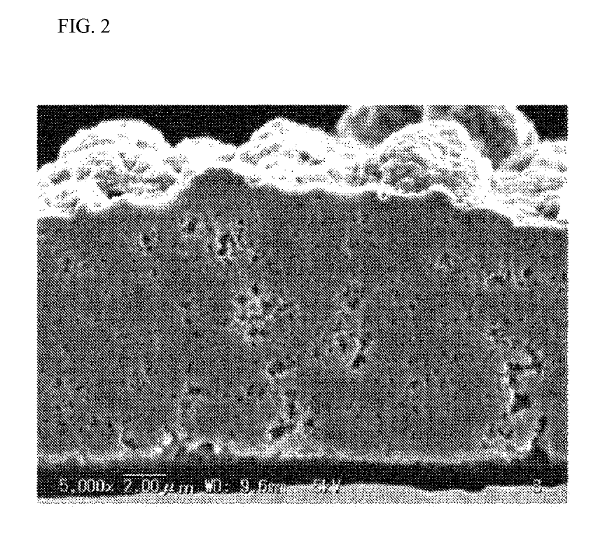

Particle size distribution: A laser diffraction particle size analyzer (manufactured by Shimadzu Corporation, trade name: SALD-3000J) was used for measuring a particle size distribution of the conductive particles prepared in (2) above, and a median diameter D50 was defined as an average particle size. Scanning electron microphotographs of the conductive particles prepared in this example are shown in FIGS. 1 and 2. FIG. 1 illustrates the appearance of the conductive particles, and it was thus confirmed that spherical composite particles of μm size were obtained. FIG. 2 illustrates a cross-section of the conductive particle, and it was thus confirmed that particles of nm size were complexed/granulated.

### (5) Compression Experiment

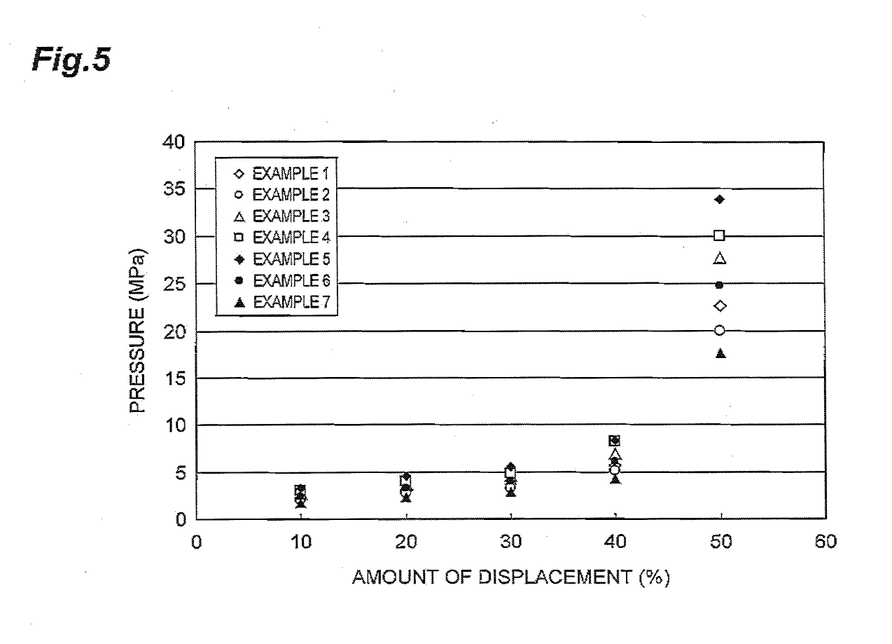

A micro compression tester (manufactured by Shimadzu Corporation, trade name: MCT-211) was used for subjecting five extracted conductive particles with a particle size of 6 μm to measurement at a measurement temperature of 25° C. with test force of 0.1 (mN), so as to obtain averages of pressures (loads) applied for causing deformation (compression) of the particle size by 10%, 20%, 30%, 40% and 50%. Relationships between the deformation volume and the pressure obtained with respect to the five particles are illustrated in FIG. 5.

### Example 2

### (1) Preparation of Material for Conductive Particles

A material for conductive particles was prepared in the same manner and under the same conditions as in (1) of Example 1 except that the amount of the latex rubber (Nipol LX430) was changed to 200 g and the amount of the Ketjen black water dispersion (Lion Paste W-311N) was changed to 1180 g (so as to attain a ratio, in terms of mass, of the rubber solid content/the amount of Ketjen black of 50/50).

### (2) Preparation of Conductive Particles

Conductive particles were obtained with the same apparatus and under the same conditions as in (2) of Example 1.

### (3) Measurement of Conductivity

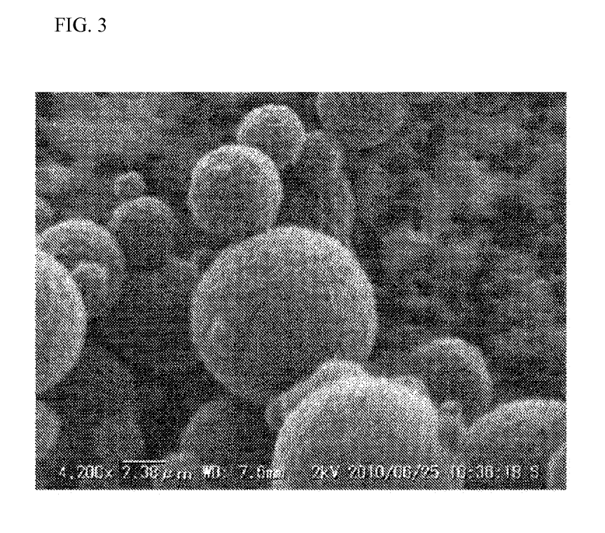

The conductivity (electrical conductivity, volume resistivity) of the conductive particles was measured with the same apparatus and under the same conditions as in (3) of Example 1. A scanning electron microphotograph of the appearance of the conductive particles prepared in this example is shown in FIG. 3. It was thus confirmed that spherical composite particles of μm size were obtained.

### (4) Compression Test

A compression experiment was carried out in the same manner as in (5) of Example 1.

### Example 3

### (1) Preparation of Material for Conductive Particles

A material for conductive particles was prepared in the same manner and under the same conditions as in (1) of Example 1 except that a latex rubber (Nipol LX416 (average particle size of contained rubber particles: 110 nm, Tg: 50° C., rubber solid content: 48%)) was used.

### (2) Preparation of Conductive Particles

Conductive particles were obtained with the same apparatus and under the same conditions as in (2) of Example 1.

### (3) Measurement of Conductivity

The conductivity (electrical conductivity, volume resistivity) of the conductive particles was measured with the same apparatus and under the same conditions as in (3) of Example 1.

### (4) Compression Test

A compression experiment was carried out in the same manner as in (5) of Example 1.

### Example 4

### (1) Preparation of Material for Conductive Particles

A material for conductive particles was prepared in the same manner and under the same conditions as in (1) of Example 1 except that 25.2 g of the latex rubber (Nipol LX416) and 25 g of a latex rubber (Nipol LX303A (average particle size of contained polystyrene-based rubber particles: 100 nm, Tg: 100° C., rubber solid content: 50%)) were used and the amount of Lion Paste W-311N was changed to 1860 g (so as to attain a rubber solid content ratio of 50/50 and a ratio, in terms of mass, of the rubber solid content/the amount of Ketjen black of 25/75).

### (2) Preparation of Conductive Particles

Conductive particles were obtained with the same apparatus and under the same conditions as in (2) of Example 1.

### (3) Measurement of Conductivity

The conductivity (electrical conductivity, volume resistivity) of the conductive particles was measured with the same apparatus and under the same conditions as in (3) of Example 1.

### (4) Compression Test

A compression experiment was carried out in the same manner as in (5) of Example 1.

### Example 5

### (1) Preparation of Material for Conductive Particles

A material for conductive particles was prepared in the same manner and under the same conditions as in (1) of Example 1 except that 108.5 g of a latex rubber (Nipol PHT8049 styrene-acrylonitrile-based rubber (average particle size of contained rubber particles: 110 nm, Tg: 110° C., rubber solid content: 46%)) was used and the amount of Lion Paste W-311N was changed to 1850 g (so as to attain a ratio, in terms of mass, of the rubber solid content/the amount of Ketjen black of 25/75).

### (2) Preparation of Conductive Particles

Conductive particles were obtained with the same apparatus and under the same conditions as in (2) of Example 1.

### (3) Measurement of Conductivity

The conductivity (electrical conductivity, volume resistivity) of the conductive particles was measured with the same apparatus and under the same conditions as in (3) of Example 1.

### (4) Compression Test

A compression experiment was carried out in the same manner as in (5) of Example 1.

### Example 6

### (1) Preparation of Material for Conductive Particles

A material for conductive particles was prepared in the same manner and under the same conditions as in (1) of Example 1 except that 100 g of a latex rubber (Nipol 8052 styrene-butadiene-based double structure (core/shell) rubber (average particle size of contained rubber particles: 320 nm, Tg: (core portion) 100° C., (shell portion) 0° C., rubber solid content: 50%) was used and the amount of Lion Paste W-311N was changed to 1850 g (so as to attain a ratio, in terms of mass, of the rubber solid content/the amount of Ketjen black of 25/75).

### (2) Preparation of Conductive Particles

Conductive particles were obtained with the same apparatus and under the same conditions as in (2) of Example 1.

### (3) Measurement of Conductivity

The conductivity (electrical conductivity, volume resistivity) of the conductive particles was measured with the same apparatus and under the same conditions as in (3) of Example 1.

### (4) Compression Test

A compression experiment was carried out in the same manner as in (5) of Example 1.

### Example 7

### (1) Preparation of Material for Conductive Particles

A material for conductive particles was prepared in the same manner and under the same conditions as in (1) of Example 1 except that 53 g of the latex rubber (Nipol LX430) was used (so as to attain a ratio, in terms of mass, of the rubber solid content/the amount of Ketjen black of 15/85).

### (2) Preparation of Conductive Particles

Conductive particles were obtained with the same apparatus and under the same conditions as in (2) of Example 1.

### (3) Measurement of Conductivity

The conductivity (electrical conductivity, volume resistivity) of the conductive particles was measured with the same apparatus and under the same conditions as in (3) of Example 1.

### (4) Compression Test

A compression experiment was carried out in the same manner as in (5) of Example 1.

### Comparative Example 1

### (1) Preparation of Material for Conductive Particles

A material for conductive particles was prepared in the same manner and under the same conditions as in (1) of Example 1 except that the amount of the latex rubber (Nipol LX430) was changed to 305 g and the amount of the Ketjen black water dispersion (Lion Paste W-311N) was changed to 321 g (so as to attain a ratio, in terms of mass, of the rubber solid content/the amount of Ketjen black of 85/15).

### (2) Preparation of Conductive Particles

Conductive particles were obtained with the same apparatus and under the same conditions as in (2) of Example 1.

### (3) Measurement of Conductivity

The conductivity (electrical conductivity, volume resistivity) of the conductive particles was measured with the same apparatus and under the same conditions as in (3) of Example 1.

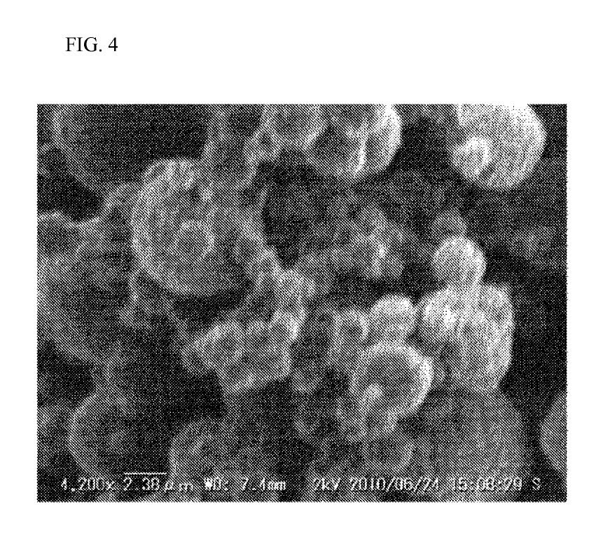

A scanning electron microphotograph of the appearance of the conductive particles prepared in this comparative example is shown in FIG. 4. Aggregation of the particles was observed. Furthermore, since good particles could not be obtained, a compression test similar to (5) of Example 1 was not conducted.

Table 1 shows evaluation results of Examples 1 to 6 and Comparative Example 1.

TABLE 1

| | | | | | | | | | Comparative |
|---|---|---|---|---|---|---|---|---|---|
| | | Example 1 | Example 2 | Example 3 | Example 4 | Example 5 | Example 6 | Example 7 | Example 1 |
| Average particle size of latex rubber | | 150 | 150 | 110 | 110/100 | 110 | 320 | 150 | 150 |
| (binder resin) [nm] | | | | | | | | | |
| Average particle size of Ketjen black | | 40 | 40 | 40 | 40 | 40 | 40 | 40 | 40 |
| (carbon-based conductive material): | | | | | | | | | |
| primary particle size [nm] | | | | | | | | | |
| Secondary particle size [nm] | | 400 or less | 400 or less | 400 or less | 400 or less | 400 or less | 400 or less | 400 or less | 400 or less |
| Binder resin/carbon-based conductive | | 25/75 | 50/50 | 25/75 | 25/75 | 25/75 | 25/75 | 15/85 | 85/15 |
| material [mass %] (solid content) | | | | | | | | | |
| Average particle size of prepared | | 7.7 | 8.3 | 6.5 | 5.7 | 5.2 | 8.2 | 5.1 | un- |
| conductive particles [μm] | | | | | | | | | measurable |
| Shape of prepared conductive particles | | Spherical | Spherical | Spherical | Spherical | Spherical | Spherical | Spherical | Spherical |
| [electron microscope] | | | | | | | | | aggregation |
| Electric conductivity [S/cm] | | 32.2 | 7.25 | 42.0 | 39.1 | 36.0 | 33.0 | 46 | 0.28 |
| Volume resistivity [Ω cm] | | 3.11 × 10⁻² | 0.138 | 2.30 × 10⁻² | 2.91 × 10⁻² | 3.34 × 10⁻² | 3.52 × 10⁻² | 1.5 × 10⁻² | 3.60 |
| Pressure for | Deformation by 10% | 2.2 | 2.0 | 2.7 | 2.9 | 3.3 | 2.4 | 1.7 | — |
| causing | Deformation by 20% | 3.0 | 2.7 | 3.7 | 3.9 | 4.5 | 3.3 | 2.3 | — |
| compression | Deformation by 30% | 3.7 | 3.3 | 4.5 | 4.8 | 5.5 | 4.0 | 2.8 | — |
| deformation | Deformation by 40% | 5.6 | 5.1 | 6.9 | 8.2 | 8.4 | 6.1 | 4.3 | — |
| of particles | Deformation by 50% | 22.6 | 20.0 | 27.7 | 30.0 | 33.9 | 24.7 | 17.5 | — |
| (MPa) | | | | | | | | | |

It was confirmed that the conductive particles of the examples were spherical particles of μm size resulting from complexation of the rubber particles of nm size and the carbon-based conductive material, were excellent in conductivity and showed good deformation volume with a small pressure, and the particle shapes were retained even in the deformation by 50%. On the contrary, in the comparative example, it was confirmed that the obtained particles formed aggregation and it was difficult to exhibit the functions as the fine particles, and the conductivity was extremely low.

1. Conductive particles comprising at least a carbon-based conductive material and a binder resin, and having an average particle size of 50 μm or less,
wherein a pressure for compressing, at 25° C., a particle size of the conductive particles to 40% of the particle size under no compression is 12 MPa or less.

2. Conductive particles comprising at least a carbon-based conductive material and a binder resin, and having an average particle size of 50 μm or less,
wherein a mass ratio of the binder resin relative to the carbon-based conductive material is 1/99 to 70/30.

3. The conductive particles according to claim 1, wherein the binder resin contains a non-water soluble elastic resin.

4. The conductive particles according to claim 3, wherein the binder resin further comprises a water soluble resin.

5. The conductive particles according to claim 3, wherein a glass transition temperature (Tg) of the non-water soluble elastic resin is −30° C. to 110° C.

6. The conductive particles according to claim 1, wherein the carbon-based conductive material is carbon black.

7. The conductive particles according to claim 1, wherein the carbon-based conductive material is Ketjen black.

8. A method of production of conductive particles, spraying a composition in which a carbon-based conductive material and a binder resin are mixed in a medium and a mass ratio of the binder resin relative to the carbon-based conductive material is 1/99 to 70/30 to volatilize the medium, and to granulate the composition while binding the carbon-based conductive material with the binder resin.

9. The method of production according to claim 8, wherein an average particle size of the conductive particles is 50 μm or less.

10. The method of production according to claim 8, wherein the binder resin comprises a non-water soluble elastic resin.

11. The method of production according to claim 10, wherein the binder resin further comprises a water soluble resin.

12. The method of production according to claim 10, wherein an average particle size of the carbon-based conductive material is 10 nm to 700 nm and an average particle size of the non-water soluble elastic resin is 50 nm to 700 nm.

13. The conductive particles according to claim 2, wherein the binder resin contains a non-water soluble elastic resin.

14. The conductive particles according to claim 13, wherein the binder resin further comprises a water soluble resin.

15. The conductive particles according to claim 13, wherein a glass transition temperature (Tg) of the non-water soluble elastic resin is −30° C. to 110° C.

16. The conductive particles according to claim 2, wherein the carbon-based conductive material is carbon black.

17. The conductive particles according to claim 2, wherein the carbon-based conductive material is Ketjen black.
